(19) United States
(12) Patent Application Publication
(10) Pub. No.: US 2024/0253259 A1
(43) Pub. Date: Aug. 1, 2024

(54) Electronic Cutting Machine Material Management

(71) Applicant: Cricut, Inc., South Jordan, UT (US)

(72) Inventors: James Oberlin, Sandy, UT (US); Adam Worsham, Bountiful, UT (US); Vance Campbell, South Jordan, UT (US); Jonathan Bowen, Saratoga Springs, UT (US); Sterling Kingdon, Cedar Hills, UT (US); David Knight, Lehi, UT (US)

(73) Assignee: Cricut, Inc., South Jordan, UT (US)

(21) Appl. No.: 18/561,223

(22) PCT Filed: May 21, 2022
(86) PCT No.: PCT/US2022/030429

§ 371 Date: Nov. 15, 2023

Related U.S. Application Data
(60) Provisional application No. 63/191,820, filed on May 21, 2021.

(51) Int. Cl. B26D 7/01; B26D 7/06

(52) U.S. Cl. CPC B26D 7/01; B26D 7/0633

(57) ABSTRACT

An electronic cutting machine includes a static dumping assembly configured to collect static charge from a workpiece placed on a working surface of the machine during use. The dumping assembly of the electronic cutting machine may include a static collection strip at least partially forming or defining the working surface of the cutting machine. The electronic cutting machine may also include a material sensor configured to detect at least one of a presence and a type of workpiece.

### CROSS-REFERENCES TO RELATED APPLICATIONS

This application claims priority to and the benefit of U.S. Provisional Patent Application No. 63/191,820 entitled “ELECTRONIC CUTTING MACHINE MATERIAL MANAGEMENT” filed on May 21, 2021, which is incorporated herein by reference.

### FIELD

This invention relates to electronic cutting machine systems, methods, and apparatuses. In particular, the present disclosure relates to the management of working materials of electronic cutting machines.

### BACKGROUND

Electronic cutting machines are used to cut or otherwise alter working materials, such as paper, vinyl, or other materials. The management of the working materials within an electronic cutting machine may include static electricity management and material sensing. Cutting machines of the prior art lack sophisticated material management capabilities, which can result in poor cutting machine performance. Therefore, a need exists to develop improved cutting machines, components, apparatuses, systems and methods that advance the art.

### SUMMARY

The subject matter of the present disclosure has been developed in response to the present state of the art, and in particular, in response to the problems and needs in the art that have not yet been fully solved by currently available electronic cutting machines. Accordingly, the present disclosure has been developed to provide an electronic cutting machine and related components, systems, assemblies, and methods that overcome many or all of the above-discussed shortcomings in the art, in accordance with various embodiments.

Disclosed herein, according to various embodiments, is an electronic cutting machine comprising a static dumping assembly configured to collect static charge from a workpiece placed on a working surface of the electronic cutting machine during use. The static dumping assembly may include a static collection strip at least partially forming and/or defining the working surface of the electronic cutting machine. The static collection strip may be adhered to a floor of the electronic cutting machine. In various embodiments, the static collection strip comprises a top surface that is flush with the working surface. In various embodiments, the static dumping assembly further includes a downward protrusion that extends from the static collection strip, transverses through the floor of the electronic cutting machine, and is electrically coupled to at least one of an electrical circuit and an electrical ground.

Also disclosed herein, according to various embodiments, is an electronic cutting machine that includes a material sensor visible. The material sensor may be visible through an aperture formed through a working surface of the electronic cutting machine. The material sensor comprising an emitter and a receiver, the emitter and the receiver arranged at an angle relative to a working surface of the electronic cutting machine. The angle may be greater than an angle of incidence of a workpiece passing over the material sensor. In various embodiments, the emitter comprises an emitter lens and the receiver comprises a receiver lens, wherein an angle is defined between the emitter lens and the receiver lens, wherein the angle is between 105 degrees and 175 degrees. In various embodiments, this angle is between 135 degrees and 165 degrees.

Also disclosed herein, according to various embodiments, is an electronic cutting machine comprising a roller assembly configured to grip and advance a workpiece through the electronic cutting machine. The roller assembly may include at least one upper roller and at least one lower roller. The lower roller may have a series of truncated pyramid-shaped protrusions disposed along an outer circumferential surface of the lower roller, each truncated pyramid-shaped protrusion extending radially outward from the lower roller. In various embodiments, the electronic cutting machine further includes one or more guides selectively movable between exposed and retracted positions and configured to maintain alignment of a workpiece as the workpiece is fed through the electronic cutting machine. Still further, the electronic cutting machine may include a door movable between open and closed positions. When the door is in the open position, the door forms a portion of a working surface configured to support a workpiece being fed through the electronic cutting machine, according to various embodiments. In various embodiments, the electronic cutting machine further comprises one or more ribs integrally formed with the rib and protruding from the portion of the working surface formed by the door while in the open position.

Also disclosed herein, according to various embodiments, is an electronic cutting machine comprising a housing have an upper surface and a lid pivotably coupled to the housing. The lid may be is movable between an open and a closed position, and the upper surface of the housing may have a channel that is configured to receive and support a user device when the lid is in the open position. In various embodiments, the channel has a lateral length that is substantially equal to a lateral dimension of an opening of the housing through which internal/working components of a working area of the electronic cutting machine are visible/accessible.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Thus, although the subject matter of the present disclosure is particularly pointed out and distinctly claimed in the concluding portion of the specification, a more complete understanding of the present disclosure may best be obtained by referring to the detailed description and claims when considered in connection with the drawing figures. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 illustrates a front, top, right perspective view of an electronic cutting machine, in accordance with various embodiments;

FIG. 2 illustrates a rear, top, left perspective view of the electronic cutting machine of FIG. 1, in accordance with various embodiments;

FIG. 3 illustrates a magnified view of a rear region of the electronic cutting machine of FIG. 2, in accordance with various embodiments;

FIG. 4 illustrates a static dumping assembly of an electronic cutting machine, in accordance with various embodiments;

FIG. 5 illustrates another configuration of a static dumping assembly of an electronic cutting machine, in accordance with various embodiments;

FIG. 6 illustrates a magnified view of a material sensor of an electronic cutting machine, in accordance with various embodiments;

FIG. 7 illustrates a material sensor of an electronic cutting machine, in accordance with various embodiments;

FIG. 8 illustrates a cross-sectional view of a material sensor of an electronic cutting machine, in accordance with various embodiments;

FIG. 9 illustrates a roller assembly of an electronic cutting machine, including a lower roller and an upper roller, in accordance with various embodiments;

FIG. 10 illustrates a perspective view of a lower roller of a roller assembly of an electronic cutting machine, the lower roller having a series of truncated pyramid-shaped protrusions extending radially outward from the lower roller, in accordance with various embodiments; and

FIG. 11 is schematic view of an example computing device that may be used to implement the systems and methods described herein, in accordance with various embodiments.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the disclosure, other embodiments may be realized and logical changes and adaptations in design and construction may be made in accordance with this disclosure without departing from the spirit and scope of the disclosure. Thus, the detailed description herein is presented for purposes of illustration only and not of limitation.

Disclosed herein, according to various embodiments, is an electronic cutting machine and related systems, assemblies, components, controls, and methods. The disclosed electronic cutting machine comprises various structures, components, features, assemblies, systems, and methods that have various benefits and/or that overcome various shortcomings of conventional machines. These various structures, components, features, assemblies, systems, and methods, although described herein as pertaining to electronic cutting machines, may be utilized and implemented in other machines, industries, applications, etc. That is, the present disclosure is not necessarily limited to cutting machines, and thus aspects of the disclosed embodiments may be adapted for performance in a variety of other uses. As such, numerous applications of the present disclosure may be realized.

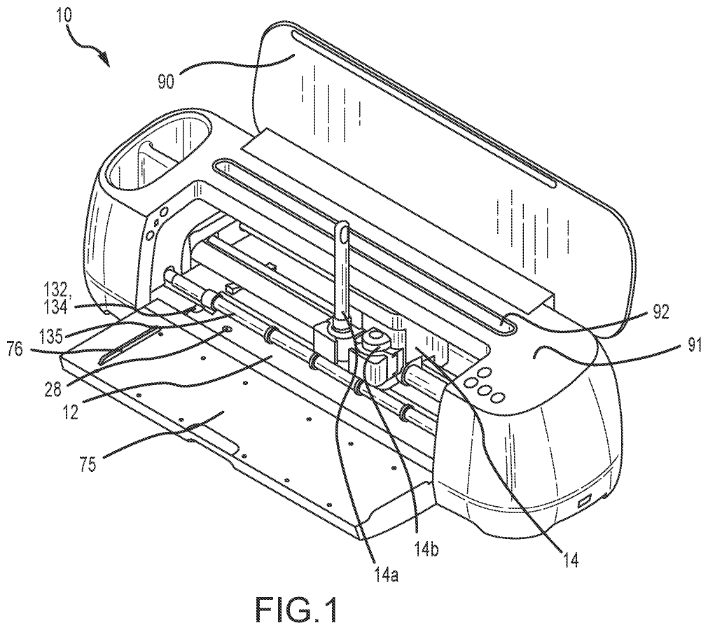

As used herein, the term “electronic cutting machine” generally refers to a crafting apparatus that conducts “work” upon a workpiece. For example, the electronic cutting machine 10 shown in FIG. 1 may be configured to perform work on different types of workpieces. A workpiece may be at least partially disposed within the electronic cutting machine 10 in order to permit the electronic cutting machine 10 to conduct work on the workpiece. The term “work” that is conducted upon the workpiece may include, but is not limited to, any number of tasks/functions performed by one or a combination of a printing device 14a and a cutting device 14b secured to a tool carriage 14 that is movably-disposed upon a member such as a rod, bar, or shaft. The movement of the tool carriage 14 along the rod may be controlled by a motor that receives actuation signals from a controller and/or a central processing unit, as described in greater detail below. The CPU may be a component of the electronic cutting machine and/or may be associated with a computing device of a user, such as laptop computer or a smart phone, that is communicatively-coupled to the electronic cutting machine.

In various embodiments, and with continued reference to FIG. 1, the “work” may include a “cutting operation” that functionally includes contact of a cutting tool 14b (such as a blade) of the cutting device with the workpiece. The blade may be detachably retained in the tool carriage. The work conducted by the cutting device arises from movement of the cutting device 14b in a vertical direction. The movement of the cutting device 14b may be controlled by one or more motors that receive actuation signals from the central processing unit CPU. In some implementations, the cutting device 14b partially or fully penetrates a thickness of the workpiece. The thickness of the workpiece may be said to be bound by a first, front surface and a second, rear surface. Although the foregoing description is directed to the use of a blade (such as, e.g., a straight blade, a castoring blade, a rotary blade, a serrated edge blade, an embossing tool, a marking tool or the like), other cutting devices may be utilized instead of a blade. Other cutting devices may include a laser, an electrically-powered rotary cutter, or the like. In various implementations, the “work” includes a printing operation by using the printing device 14a. The printing operation may including depositing ink from a nozzle of the printing device 14a onto one or more of the first, front surface of the workpiece and the second, rear surface of the workpiece.

The electronic cutting machine 10 may conduct work in a manner that provides a combo operation such as a print and cut operation. The “print and cut operation” may in some instances be executed as a “print then cut” operation such that the printing operation is conducted prior to the cutting operation.

In various embodiments, workpieces that can be worked upon by the electronic cutting machine may include various shapes, sizes, geometries or material compositions. The shape/geometry may include, for example, a square or rectangular shape. Alternatively, the shape may include non-square or non-rectangular shapes, such as circular shapes, triangular shapes or the like.

In some instances, the workpiece includes, or is detachably mounted to, a workpiece mat that provides support to the workpiece during the work. The workpiece mat may have predetermined dimensions. In various embodiments, the workpiece is a roll of material, and thus use of the electronic cutting machine 10 may include reeling a desired amount of workpiece material from the roll of workpiece material.

The material composition of the workpiece may include paper-based (e.g., paperboard or cardboard) and/or non-paper-based products (e.g., vinyl, foam, rigid foam, cushioning foam, plywood, veneer, balsawood or the like). Nevertheless, although various implementations of workpiece material composition may be directed to paper, vinyl or foam-based products, the material composition of the workpiece is not limited to a particular material and may include any cuttable material. Further, the electronic cutting machine 10 may be configured to work with

In some implementations, the electronic cutting machine 10 may be utilized in a variety of environments when conducting work on the workpiece. For example, the electronic cutting machine 10 may be located within one's home and may be connected to an external computer system (e.g., a desktop computer, a laptop computer, a dedicated/non-integral/dockable [standalone] controller device which is not a general purpose computer or the like) such that a user may utilize software that may be run by the external computer system in order for the electronic cutting machine 10 to conduct work on the workpiece. In another example, the electronic cutting machine 10 may be referred to as a “stand alone system,” in some implementations, that integrally includes one or more of an on-board monitor, an on-board keyboard, an on-board CPU including a processor, memory and the like. In such an implementation, the electronic cutting machine 10 may operate independently of any external computer systems in order to permit the electronic cutting machine 10 to conduct work on the workpiece.

The electronic cutting machine 10 may be implemented to have any desirable size, shape or configuration. For example, the electronic cutting machine 10 may be sized to work on a relatively large workpiece (e.g., plotting paper). Alternatively, the electronic cutting machine 10 may be configured to work on a relatively small workpiece.

FIG. 1 illustrates a perspective view of an embodiment of an electronic cutting machine 10. Machine 10 includes a working surface 12 and the tool carriage 14. A workpiece may be placed on working surface 12 and machine 10 may be configured to articulate the workpiece forward-and-backward (e.g., into and out of the machine using one or more drive rollers), the tool carriage 14 may be driven laterally (side-to-side) along a rail or rod, and the tool(s) 14a, 14b of the tool carriage 14 may be driven vertically to impinge on the workpiece to perform work thereon.

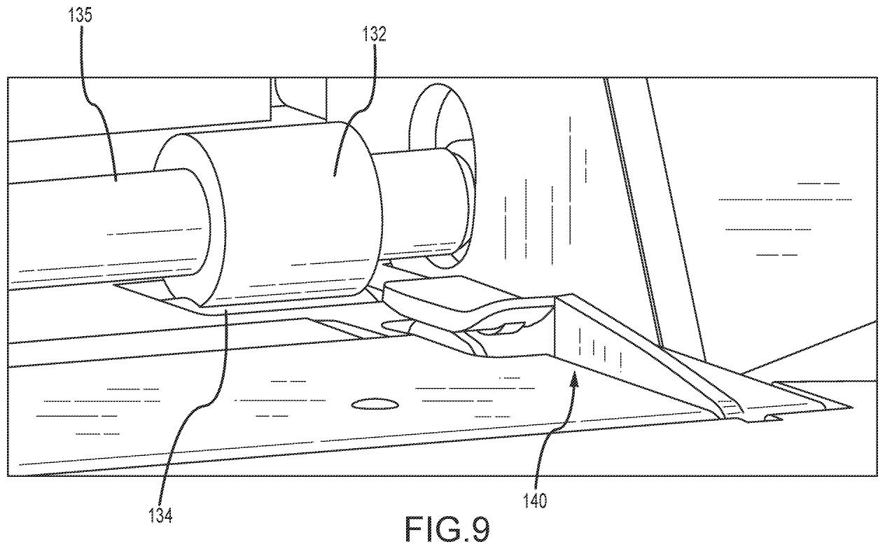

The electronic cutting machine 10 may further include a door 75 operable between open and closed positions. When the door 75 is in the open position, a workpiece may be inserted into the cutting machine 10. The door 75 may be selectively opened and closed via a hinge mechanism, where the door 75 is connected to an outer housing of the cutting machine 10. Additionally, the door 75 may form a portion of the working surface 12 when the door 75 is in the open position. Accordingly, the portion of the working surface 12 formed by the door 75 may include one or more ribs 76 configured to function as guides for maintaining lateral alignment and tracking of the workpiece fed through the machine 10 during printing/cutting operations. In various embodiments, the rib 76 defines a longitudinal axis that extends parallel to the forward-backward direction the workpiece advances as it is fed through the machine 10. The rib 76 may be integrally formed with the door 75 and may cooperate with one or more other guides 140 (FIG. 9) extending from the working surface.

In some implementations, the machine 10 further includes a lid 90 hingedly/pivotably coupled to the machine housing such that the lid 90 is selectively movable between open and closed positions. In the open position, as shown in FIG. 1, an upper surface 91 of the machine housing is uncovered (e.g., visible). Said differently, at least a portion of the upper surface 91 of the machine housing is covered when the lid 90 is in the closed position but then is uncovered when the lid 90 is in the open position. The upper surface 91 of the machine housing may be substantially planar, and the underside (i.e., lower surface) of the lid 90 may be configured to extend parallel to the upper surface 91 of the machine housing.

In various embodiments, this upper surface 91 of the machine housing may define a channel 92 that is configured to receive and support a user device when the lid 90 is in the open position. For example, a user device, such as a phone, tablet, or other mobile computing device, may at least partially received within the channel 92 to support/secure the computing device. In other words, an edge or side of the user computing device may rest at least partially within the channel 92 to support the user device in an orientation that enables the user view contents displayed on a screen of the user device (e.g., during operation of the device). In various embodiments, the channel 92 has a lateral length that is substantially equal to the lateral dimension of the opening of the machine housing through which the internal/working components of the working area of the machine are visible/accessible. In various embodiments, the lid 90 in the open position may also be configured to function as a backstop/backrest for the computing device, and thus one edge of the computing device of the user may be engaged within the channel 92 and another surface/edge of the computing device may rest or lean against the lid 90 in the open position.

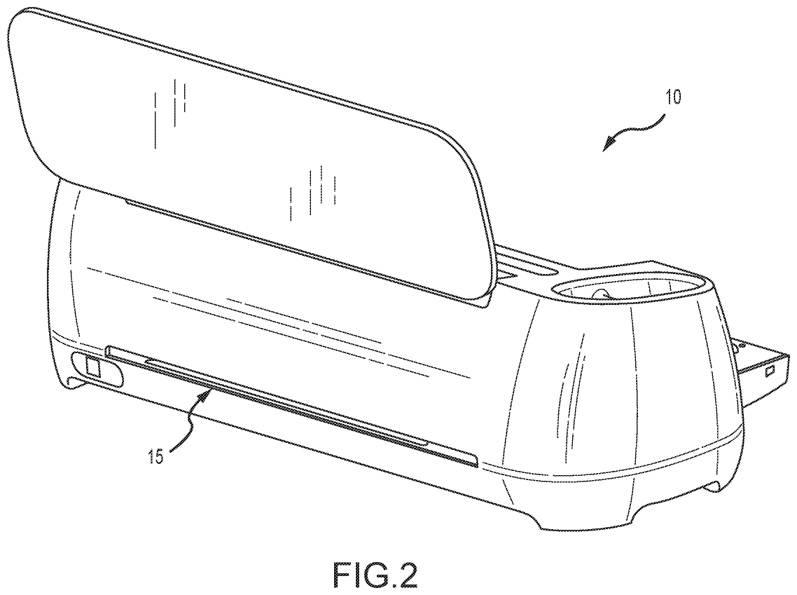

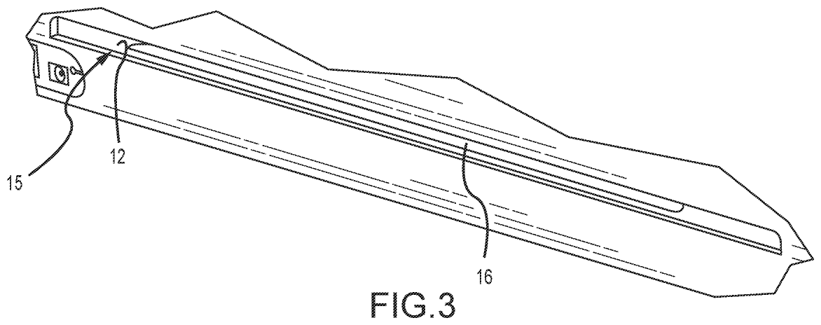

In various embodiments, and with reference to FIGS. 2 and 3, the electronic cutting machine 10 has a slot 15 configured to allow the workpiece material to pass out of the back of machine 10 as it is articulated during operation. As the workpiece is articulated forward-and-backward on working surface 12 of machine 10, static electricity may tend to build up. In order to mitigate the harmful effects of such static build-up during operation, the machine 10 may include a static dumping assembly.

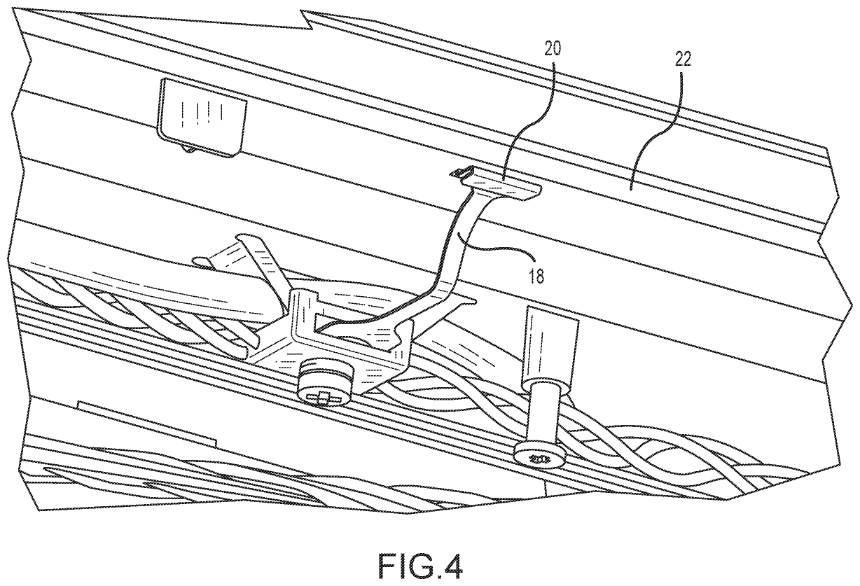

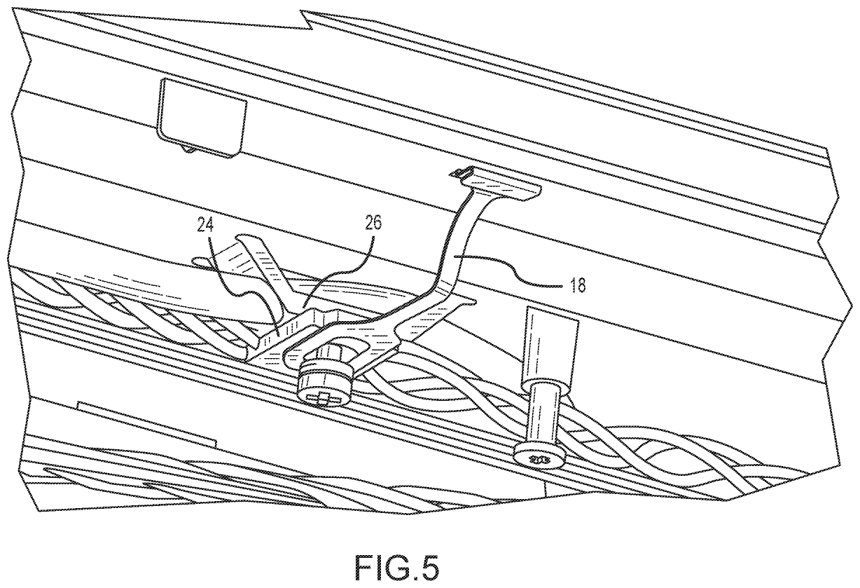

The static dumping assembly, described in greater detail below with reference to FIGS. 4 and 5, may include a static collection strip 16. The static collection strip 16 forms at least a portion of the working surface 12 of the electronic cutting machine 10, according to various embodiments. Said differently, the static collection strip 16 of the static dumping assembly may define a section of the working surface 12 and may be positioned and/or otherwise disposed to face and/or contact the workpiece as it moves in and out of the machine (i.e., across the working surface 12). In various embodiments, the static collection strip 16 is adhered to the machine housing that defines the working surface. In various embodiments, the machine housing may define a groove or depression within which the static collection strip 16 is disposed. In various embodiments, the static collection strip 16 may be substantially flush with the working surface 12 of the machine 10.

In various embodiments, and with reference to FIGS. 4 and 5, the static dumping assembly further includes an electrical pathway that extends from the static collection strip 16 to a dump circuit and/or an electrical ground connection. For example, as shown in FIG. 4, which is a rear, lower, close-up, perspective view of machine 10 underneath the working surface 12 (e.g., showing the underside of the floor 22 of the machine), with a lower housing portion removed for visualization. A conducting member 18, which may be a component of the static dumping assembly, carries the electric charge from static collection strip 16 to a dump circuit or electrical ground. In various embodiments, a downward protrusion 20 may be disposed between the static collection strip 16 and the conducting member 18. In various embodiments, the downward protrusion 20 extends down through a floor 22 of machine 10 that forms the working surface 12, and the conducting member 18 may contact downward protrusion 20, or may contact strip 16 directly, such that static charge collected by strip 16 is passed through conducting member 18 and into either a circuit or electrical ground contact.

In various embodiments, conducting member 18 directs electric charge directly to a ground contact, either an external ground or a floating ground such as a frame member of machine 10 (e.g., FIG. 4). In various embodiments, conducting member 18 may first direct electricity to a circuit 24, and circuit 24 may include a resistor or other components through which electricity flows before ground connection 26 (e.g., FIG. 5). In various embodiments, the resistor of circuit 24 may include a time constant to help increase time to charge sheet metal so that the circuit board does not jump with discharge onto strip 16.

Referring back to FIG. 1, in various embodiments the machine 10 includes a material sensor 28 that is configured to determine whether or not the workpiece is disposed on the working surface 12. In various embodiments, material sensor 28 may also facilitate determination of other characteristics of the workpiece, such as whether or not the workpiece includes or is mounted to a workpiece support mat or whether the workpiece is matless. Workpiece support mats, also reference to as material mats or cutting mats, maybe inherently limited in length because they are typically too thick and rigid to roll-up. Additionally, due to their robust construction and more expense materials used to make cutting mats compared to workpieces like vinyl and paper, it is generally cost prohibitive to make lengthy cutting mats. Accordingly, the cutting machine 10 may cut workpieces of much longer lengths in matless cutting since cutting operations are not inhibited by the use of a fixed-length cutting mat. However, in order inform the cutting machine of a workpiece positioned on the working surface 12, the material sensor 28 may be configured to not only determine a presence of a workpiece, but the characteristics and/or properties of the workpiece.

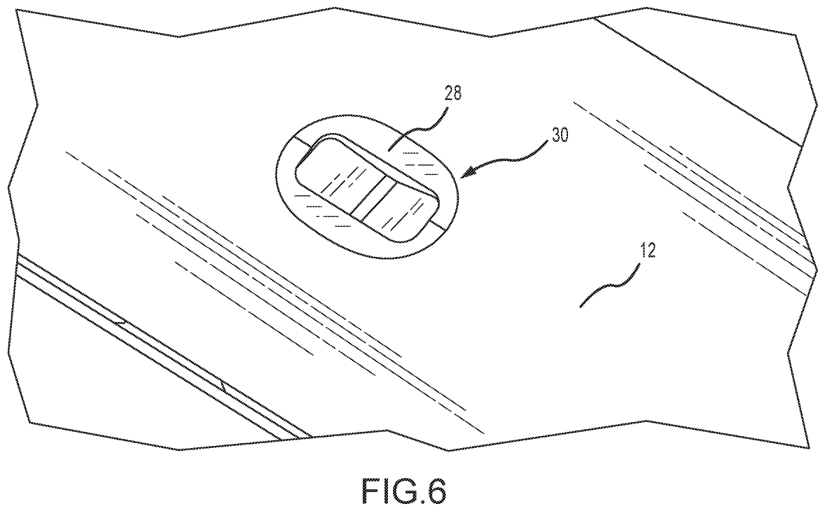

For example, the material sensor 28 may be configured to sense a multitude of different types of workpieces having a wide range of reflectance, transparency, and other properties that may affect the ability of the sensor 28 to sense the workpiece. In various embodiments, workpieces having clear backers may be more difficult to sense than materials having opaque backers. As shown in the close-up view of FIG. 6, sensor 28 may be disposed below working surface 12 but may be visible through an aperture 30 formed through the working surface 12, thereby enabling sensor 28 to emit and receive light for sensing the color, type, or other characteristics of the workpiece placed on the working surface 12 by the user.

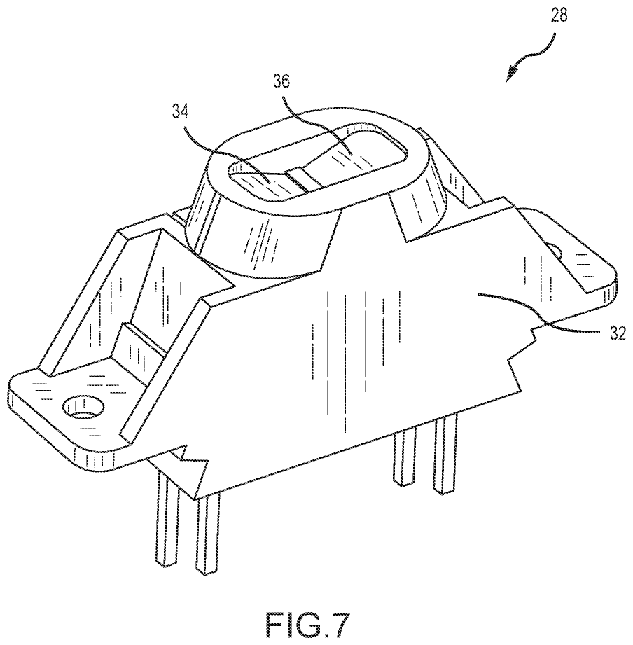

FIG. 7 illustrates an isolated view of sensor 28, including a housing 32, an emitter lens 34, and a receiver lens 36. A light emitter, such as an infrared (IR) ultraviolet, visible light emitter, may be configured to direct light through the aperture 30 via the emitter lens 34 to bounce the light off the workpiece that is disposed on an opposite side of the working surface 12 than the sensor 28. The light that is reflected off the workpiece may be received by the sensor 28 through the aperture 30 via the receiver lens 36.

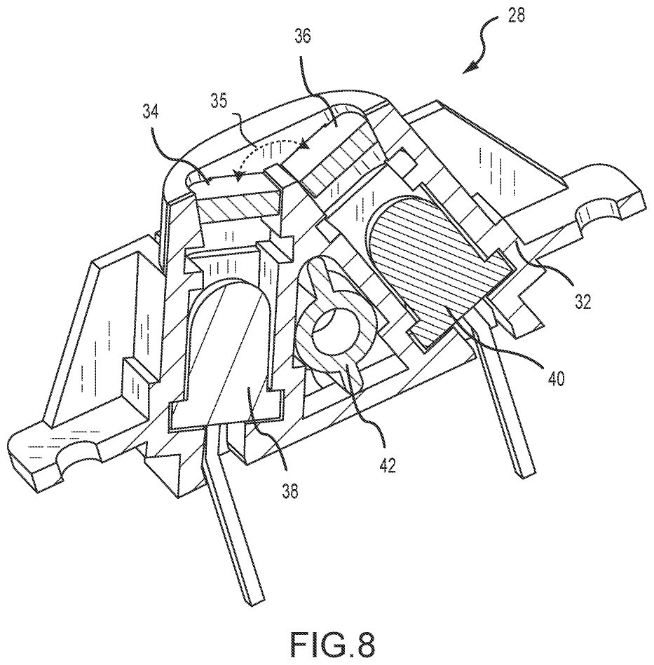

The cross-sectional view of sensor 28 in FIG. 8 shows an embodiment of an emitter 38 and receiver 40 situated within housing 32. In order to reduce cross-talk between emitter 38 and receiver 40, the housing 32 of the sensor 28 may include a central portion 42 forming a barrier between portions of housing 32 already separating emitter 38 and receiver 40. In various embodiments, enough material, including housing 32 and central portion 42 thereof, forms a barrier to reduce light from emitter 38 transmitting light directly across to receiver 40 without first traveling through lenses 34, 36. In addition, the central portion 42 and the rest of housing 32 situated around emitter 38, and particularly around receiver 40, limits the transmission of ambient light to receiver 40 through housing 32, lenses 34, 36, or elsewhere. In this way, undesirable effects of ambient light received by receiver 40 is reduced to improve accuracy of readings/sensing of the workpiece by the sensor 28.

The properties of the workpiece will vary depending on the type of material used. In various embodiments, the emitter 38 and the receiver 40 are angled relative to one another. Similarly, in these examples, the lenses 34, 36 are each angled relative to one another and traverse to a major plane of the workpiece when disposed on the working surface 12. The angle of emitter and receiver lenses 34, 36, as oriented relative to working surface 12 of machine 10 and therefore also relative to a major plane of the workpiece passing over sensor 28, may be arranged such that the angle is beyond an angle of incidence of any materials that may be used. In this way, light will bounce from emitter lens 34, through aperture 30 and off the workpiece, and back through the aperture 30 and receiver lens 36 regardless of the workpiece used. That is, the angled lenses 34, 36 allow for saturation of the light reflected off the workpiece regardless of the type of workpiece used (parallel lenses may inhibit saturation). The angled lenses 34, 36 also provide more room for the light to scatter and reflect for sensing by the sensor 28 compared to emitter and reflector lenses arranged in parallel. Such materials on which this angle of incidence is based may include, for example, PET and PVC materials. In various embodiments, the angle 35 defined between the respective surfaces of the lenses 34, 36 is between 105 degrees and 175 degrees. In various embodiments, the angle 35 defined between the lenses 34, 36 is between 120 degrees and 170 degrees. In various embodiments, the angle 35 defined between the lenses 34, 36 is between 135 degrees and 165 degrees.

Ambient IR light emitted from ambient light sources (e.g., the sun, incandescent lights, etc.) may cause false triggering of the sensor 28 resulting in false detection of a cutting material on the working surface. This type of false triggering is further exacerbated the closer the sensor 28 is disposed to the working surface. In various embodiments, the emitter 38 is configured to emit light using a modulated pulse to inhibit ambient light and/or other environmental factors outside the machine 10 from falsely tripping the sensor 28. The receiver 40 may employ a frequency computer chip that is configured to detect a frequency signal corresponding to the modulated pulse of light reflected off the workpiece and may use an encoded pattern to improve detection in areas of high ambient light interference.

Referring to FIGS. 1, 9, and 10, the cutting machine 10 may further include a roller assembly that is configured to feed the workpiece backward and forward through the cutting machine 10. The roller assembly may include an upper roller 132 (e.g., passive roller) and a lower roller 134 (e.g., a drive roller). The lower roller 134 may be drive by the motor while the upper roller 132 is passive. The roller assembly may include three lower rollers and three upper rollers, four lower rollers and four upper rollers, or any combination thereof. The rollers 132, 134 may be biased toward one another to provide a force sufficient for gripping and actuating the workpiece through the cutting machine without slipping. In some examples, as shown in FIG. 9, the cutting machine 10 includes one or more guides 140 configured to function as “bumpers” to force the workpiece laterally in the x-direction and into alignment as the workpiece is fed in the forward-backward y-direction. The one or more guides 140 may also be selectively raised and lowered along the z-axis relative to the working surface 12 to accommodate various widths of cut material. A user has the option to lower all guides 140 if desired to cut materials without them. A user also has the option to raise any of the guides 140, which may stay up during a cutting operation, so that the outer edges of the material is physically bounded thereby and thus alignment of cut material is maintained during movement thereof.

In some examples, the roller assembly includes at last one additional drive roller and the passive roller 134 may be configured to slide laterally along rail (i.e., roller bar) 135 so that it can selectively engage with either of the drive rollers to accommodate a variety of cut material thicknesses.

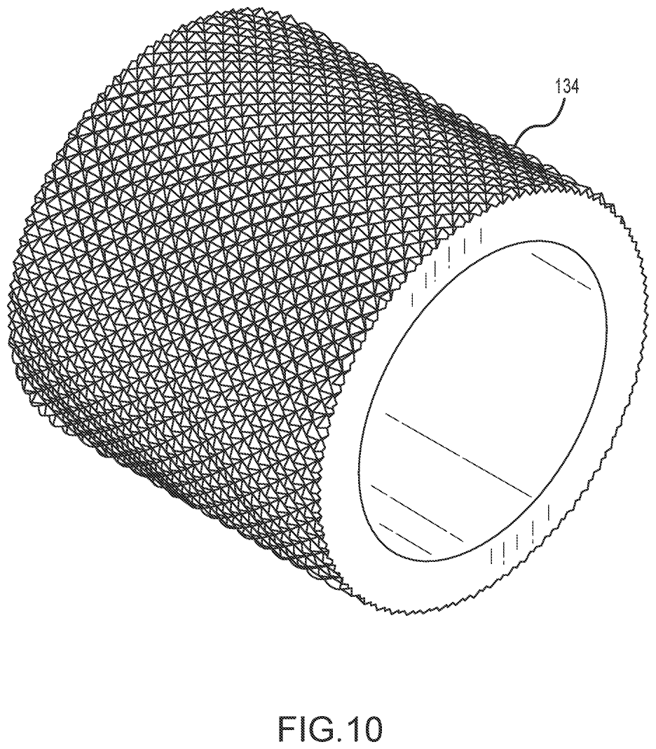

FIG. 10 shows a perspective view of the lower drive roller 134 including a surface topography along its outer circumference that is configured to provide a gripping characteristic to optimize tracking of the workpiece by reducing slipping/misalignment of the workpiece between the upper roller 132 and the lower roller 134. The surface topography may be textured via knurling or machining to provide a series of pyramidal protrusions (e.g., truncated pyramid-shaped protrusions). As such, the surface topography is configured to withstand cyclical loading and high pressures required for managing large form cut materials during operation. In general, the lower roller 134 may include any desirable protrusion surface geometry that provides geometric features that improve gripping with the workpiece while withstanding biasing forces from the opposing configuration of the upper roller 132 and the lower roller 134 of 10 kg-f (+/−10%) or more without breaking with repeated use.

The surface topography may include multiple rows of truncated pyramidal protrusions each laterally spaced from another. Protrusions in rows adjacent to one another may not be perfectly superposed over each other when viewed from the lateral direction x. The orientation of the flats of the knurled protrusions may be rotated and cut an angle (e.g., 45-degrees) in order to reduce noise during operation of the cutting machine 10. The surface topography may include any pattern of protrusions that is suitable to gripping the workpiece.

In other configurations, the upper roller 132 is formed (e.g., milled) in a substantially similar manner as described above to define protrusions like that of the lower roller 134 while the lower roller 134 is formed from a slick plastic material and operates in a passive manner, so long as the passive roller (e.g., the lower roller 134) includes the slick material described above and the actively driven roller (e.g., the upper roller 132) includes the higher traction, contoured surface geometry noted above, without departing from the functionalities of the roller assembly described herein.

Furthermore, in other configurations, the cutting machine 10 includes more rollers than the upper roller 132 and the lower roller 134 extending laterally across upper roller bar 135 and the lower roller bar (e.g., some configurations of the cutting machine 10 may include three lower rollers and three upper rollers, four lower rollers and four upper rollers, or more). In order to ensure the best automatic alignment of the workpiece fed through the cutting machine 10, however, multiple upper rollers 132 and lower rollers 134 may be defined by the same (or close to the same) diameter. For example, in at least one exemplary configuration, the diameter of each of a set of multiple lower rollers 134 may be configured to be about plus-or-minus about 5-microns of one another.

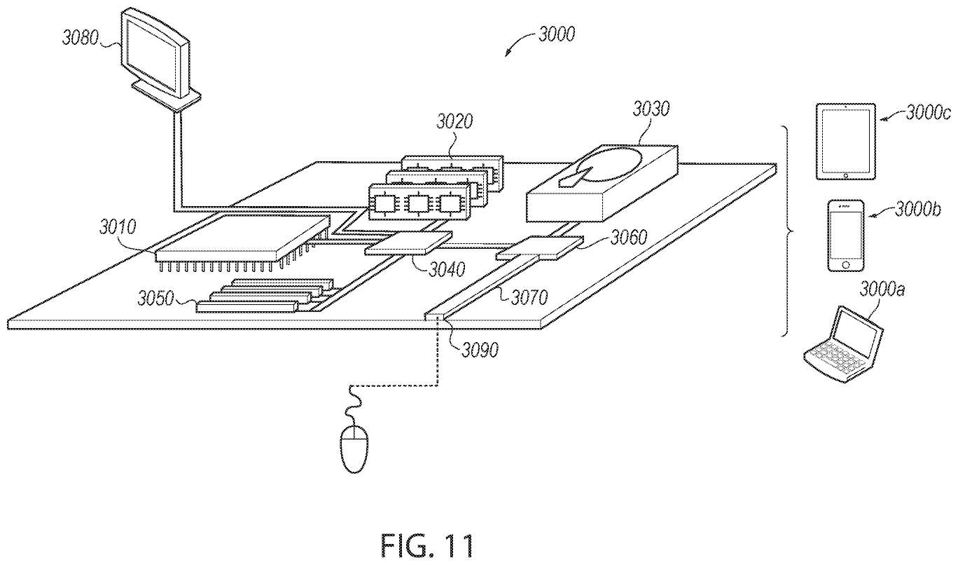

FIG. 11 is schematic view of an example computing device 3000 that may be used to implement the systems and methods described in this document. The components 3010, 3020, 3030, 3040, 3050, and 3060 shown at FIG. 11, their connections and relationships, and their functions, are meant to be exemplary only, and are not meant to limit implementations of the inventions described and/or claimed in this document. As mentioned above, the various features and functionality of the computing device 3000 may be implemented in a standalone computer (e.g., a standalone controller), may be integrated within the electronic cutting machine 10 itself, or may be implemented with various other computing devices, as described below. Said differently, the computing device 3000 may generally include one or more processors and a storage medium having instructions stored thereon. The one or more processors may be configured to implement various logical operations in response to execution of instructions, for example, instructions stored or loaded on the tangible, non-transitory, computer-readable medium configured to communicate with the controller. The system program instructions may include instructions that, in response to execution by a processor, cause the controller to control operation of the electronic cutting machine 10. In various embodiments the one or more processors and the storage medium may be integrated into the electronic cutting machine 10 itself, and/or other devices may be coupled in wired or wireless control communication with the electronic cutting machine 10, such as one or more servers, a laptop, a personal computer, a smartphone, etc.

The computing device 3000 may include a processor 3010, memory 3020, a storage device 3030, a high-speed interface 3040 connecting to the memory 3020 and high-speed expansion ports 3050, and a low-speed interface 3060 connecting to a low speed bus 3070 and a storage device 3030. Each of the components 3010, 3020, 3030, 3040, 3050, and 3060, may be interconnected using various busses, and may be mounted on a common motherboard or in other manners as appropriate. The processor 3010 can process instructions for execution within the computing device 3000, including instructions stored in the memory 3020 or on the storage device 3030 to display graphical information for a graphical user interface (GUI) on an external input/output device, such as display 3080 coupled to high-speed interface 3040. In other implementations, multiple processors and/or multiple buses may be used, as appropriate, along with multiple memories and types of memory. Also, multiple computing devices 3000 may be connected, with each device providing portions of the necessary operations (e.g., as a server bank, a group of blade servers, or a multi-processor system).

The memory 3020 may store information non-transitorily within the computing device 3000. The memory 3020 may be a computer-readable medium, a volatile memory unit(s), or non-volatile memory unit(s). The non-transitory memory 3020 may be physical devices used to store programs (e.g., sequences of instructions) or data (e.g., program state information) on a temporary or permanent basis for use by the computing device 3000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random access memory (SRAM), phase change memory (PCM) as well as disks or tapes.

The storage device 3030 may be capable of providing mass storage for the computing device 3000. In some implementations, the storage device 3030 is a computer-readable medium. In various different implementations, the storage device 3030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 3020, the storage device 3030, or memory on processor 3010.

The high-speed interface 3040 may manage bandwidth-intensive operations for the computing device 3000, while the low speed interface 3060 manages lower bandwidth-intensive operations. Such allocation of duties is exemplary only. In some implementations, the high-speed interface 3040 is coupled to the memory 3020, the display 3080 (e.g., through a graphics processor or accelerator), and to the high-speed expansion ports 3050, which may accept various expansion cards (not shown). In some implementations, the low-speed interface 3060 is coupled to the storage device 3030 and a low-speed expansion port 3090. The low-speed expansion port 3090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the electronic cutting machine may be configured, via one or more processors executing program instructions, to perform various operations/functions. For example, the electronic cutting machine may be configured to detect a presence of a workpiece material before allowing work to be performed upon the workpiece by the tools of the electronic cutting machine. Detecting a presence of a workpiece may include receiving sensor data from a material sensor. As mentioned above, the material sensor may be disposed in proximity to a working surface of the electronic cutting machine. In various embodiments, the method performed by the one or more processors may include determining one or more characteristics of the workpiece. For example, the determination step may include receiving signal data from the material sensor and analyzing the signal data to determine the type of workpiece material positioned within the machine.

The method may further include conveying this determined information pertaining to the presence and/or type of workpiece to an operating control program of the machine to verify if the detected/determined workpiece matches the settings manually entered by a user and/or to verify if the detected/determined workpiece characteristics fit the planned/expected work to be performed by the electronic cutting machine on the workpiece.

The method steps and functionality mentioned above are not exhaustive lists of the methods that may be performed with the aforementioned components of the electronic cutting machine, and instead these details merely represent exemplary methods and steps. Indeed, the steps and operations described herein may have additional steps, the steps from one method may be incorporated into other methods, and other methods may also fall under the scope of this disclosure.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. No claim element is intended to invoke 35 U.S.C. 112(f) unless the element is expressly recited using the phrase “means for.”

As used herein, the terms “including,” “comprising,” “having,” and variations thereof mean “including but not limited to” unless expressly specified otherwise. Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “some embodiments,” “various embodiments,” “one example,” “an example,” “some examples,” “various examples,” “one implementation,” “an implementation,” “some implementations,” “various implementations,” “one aspect,” “an aspect,” “some aspects,” “various aspects,” etc., indicate that the embodiment, example, implementation, and/or aspect described may include a particular feature, structure, or characteristic, but every embodiment, example, implementation, and/or aspect may not necessarily include the particular feature, structure, or characteristic. Moreover, such phrases are not necessarily referring to the same embodiment, example, implementation, or aspect. Thus, when a particular feature, structure, or characteristic is described in connection with an embodiment, example, implementation, and/or aspect, it is submitted that it is within the knowledge of one skilled in the art to affect such feature, structure, or characteristic in connection with other embodiments, examples, implementations, and/or aspects, whether or not explicitly described. Absent an express correlation to indicate otherwise, features, structure, components, characteristics, and/or functionality may be associated with one or more embodiments, examples, implementations, and/or aspects of the present disclosure. After reading the description, it will be apparent to one skilled in the relevant art how to implement the disclosure in alternative configurations.

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

All ranges and ratio limits disclosed herein may be combined. Numbers, percentages, ratios, or other values stated herein are intended to include that value, and also other values that are “about” or “approximately” the stated value, as would be appreciated by one of ordinary skill in the art encompassed by embodiments of the present disclosure, unless otherwise defined herein. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Different cross-hatching may be used throughout the figures to denote different parts but not necessarily to denote the same or different materials. Surface shading lines may be used throughout the figures to denote different parts or areas but not necessarily to denote the same or different materials. In some cases, reference coordinates may be specific to each figure. Furthermore, the connecting lines shown in the various figures contained herein are intended to represent exemplary functional relationships and/or physical couplings between the various elements. It should be noted that many alternative or additional functional relationships or physical connections may be present in a practical system.

Any reference to attached, fixed, connected or the like may include permanent, removable, temporary, partial, full and/or any other possible attachment option. Additionally, any reference to without contact (or similar phrases) may also include reduced contact or minimal contact. In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The schematic flow chart diagrams included herein are generally set forth as logical flow chart diagrams. As such, the depicted order and labeled steps are indicative of one or more embodiments of the presented method. The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An electronic cutting machine, comprising a static dumping assembly configured to collect static charge from a workpiece placed on a working surface of the electronic cutting machine during use.

2. The electronic cutting machine of claim 1, wherein the static dumping assembly comprises a static collection strip at least partially forming or defining the working surface of the electronic cutting machine.

3. The electronic cutting machine of claim 2, wherein the static collection strip is adhered to a floor of the electronic cutting machine.

4. The electronic cutting machine of claim 3, wherein the static collection strip comprises a top surface that is flush with the working surface.

5. The electronic cutting machine of claim 3, wherein the static dumping assembly further includes a downward protrusion that extends from the static collection strip, transverses through the floor of the electronic cutting machine, and is electrically coupled to at least one of an electrical circuit and an electrical ground.

6. An electronic cutting machine, comprising a material sensor visible through an aperture formed through a working surface, the material sensor comprising an emitter and a receiver, the emitter and the receiver arranged at an angle relative to a working surface of the electronic cutting machine.

7. The electronic cutting machine of claim 6, the angle is greater than an angle of incidence of a workpiece passing over the material sensor.

8. The electronic cutting machine of claim 6, wherein the emitter comprises an emitter lens and the receiver comprises a receiver lens, wherein an angle is defined between the emitter lens and the receiver lens, wherein the angle is between 105 degrees and 175 degrees.

9. The electronic cutting machine of claim 6, wherein the emitter comprises an emitter lens and the receiver comprises a receiver lens, wherein an angle is defined between the emitter lens and the receiver lens, wherein the angle is between 135 degrees and 165 degrees.

10. An electronic cutting machine comprising a roller assembly configured to grip and advance a workpiece through the electronic cutting machine, the roller assembly comprising:
at least one upper roller; and
at least one lower roller,
wherein the lower roller comprises a series of truncated pyramid-shaped protrusions disposed along an outer circumferential surface of the lower roller, each truncated pyramid-shaped protrusion extending radially outward from the lower roller.

11. The electronic cutting machine of claim 10, further comprising one or more guides selectively movable between exposed and retracted positions and configured to maintain alignment of a workpiece as the workpiece is fed through the electronic cutting machine.

12. The electronic cutting machine of claim 10, further comprise a door movable between open and closed positions, wherein, when the door is in the open position, the door forms a portion of a working surface configured to support a workpiece being fed through the electronic cutting machine.

13. The electronic cutting machine of claim 12, further comprising one or more ribs integrally formed with the rib and protruding from the portion of the working surface formed by the door while in the open position.

14. (canceled)

15. (canceled)
